(19) United States
(12) Patent Application Publication
(10) Pub. No.: US 2017/0035023 A1
(43) Pub. Date: Feb. 9, 2017

(54) Gravity Fed Animal Feeder

(71) Applicants: Bill Teinert, Hondo, TX (US); Benito Valdes, Eagle Pass, TX (US)

(72) Inventors: Bill Teinert, Hondo, TX (US); Benito Valdes, Eagle Pass, TX (US)

(21) Appl. No.: 14/818,206

(22) Filed: Aug. 4, 2015

(51) Int. Cl. A01K 5/02

(52) U.S. Cl. CPC A01K 5/0225

(57) ABSTRACT

The gravity fed animal feeder of the present invention provides incorporates a cradle and a hopper that can be joined into a complete feeder. The hopper has a hollow interior shaped generally like an inverted, truncated pyramid or cone that attaches to a fully integrated head. The head has a center feed aperture through which feed drops onto a bottom plate. The feed is an accessible by animals through feed ports. At the outer edge of the feed ports is a feed arrest member which helps keep feed from accidentally dropping off of the bottom plate.

This application is based upon and claims priority from U.S. Provisional application Ser.. No. 62/032,659, which is incorporated herein by reference.

### BACKGROUND OF THE INVENTION

Field of the Invention

Applicants' invention relates to a gravity fed animal feeder. More particularly, it relates to an improved design of a gravity fed animal feeder that improves feed movement and dispersal.

Background Information

A common method of hunting involves using a feeder to entice deer to a specific location. A feeder provides a way for hunters and other enthusiasts to feed deer.

A healthy deer herd is one of the most important factors contributing to a successful hunting season.

### SUMMARY OF THE INVENTION

The gravity fed animal feeder of the present invention provides incorporates a cradle and a hopper that can be joined into a complete feeder. The hopper has a hollow interior shaped generally like an inverted, truncated pyramid or cone that attaches to a fully integrated head.

The gravity fed animal feeder of the present invention provides a novel feeder can be filled while standing on the ground.

### BRIEF DESCRIPTION OF THE DRAWINGS

FIG. 1 is a perspective view of the gravity fed animal feeder and rack.

FIG. 2 is a bottom perspective view of the gravity fed animal feeder.

FIG. 3 is a side perspective, transparent view of the gravity fed animal feeder.

FIG. 4 is an exploded, side perspective view of the gravity fed animal feeder.

FIG. 5 is a side perspective view of the head portion of the gravity fed animal feeder.

FIG. 6 is a top view looking into the interior portion of the gravity fed animal feeder.

### DETAILED DESCRIPTION OF THE PREFERRED EMBODIMENT

| | |
|---|---|
| 10 | Feeder |
| 12 | Hopper |
| 12a | Hopper top |
| 12b | Hopper bottom |
| 14 | Cradle |
| 16 | Head |
| 18 | Lid |
| 20 | Rack |
| 22 | Feed port |
| 24 | Leg |
| 26 | Foot |
| 28 | Brace |
| 30 | Latch |
| 32 | Shoulder |
| 34 | Head angle |
| 36 | Feed arrest member |
| 38 | Bottom plate |
| 40 | Fin |
| 42 | Hinge |
| 44 | Hopper angle |
| 46 | Head rim |
| 48 | Lock |
| 50 | Feed aperture |

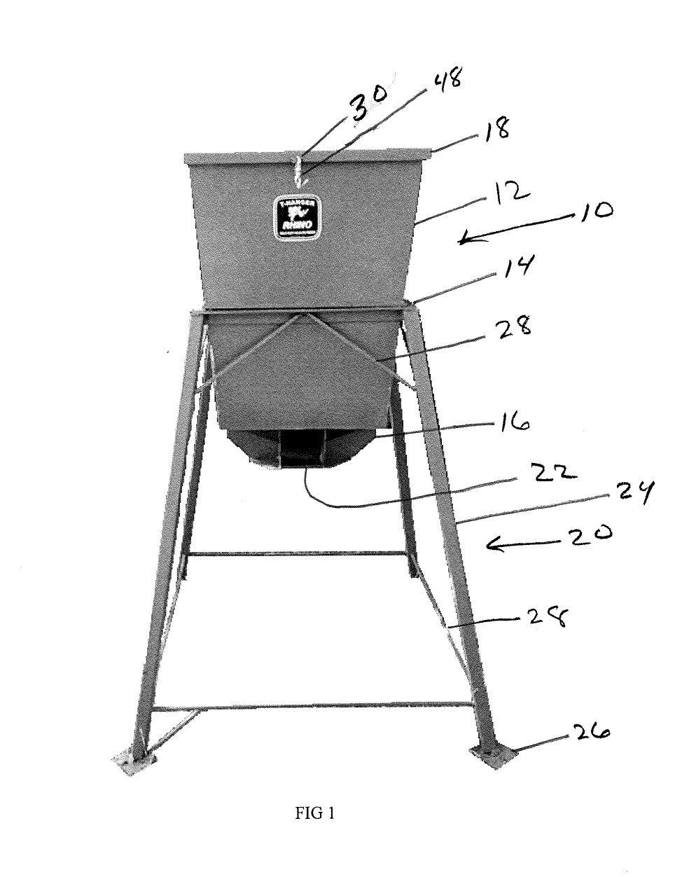

Referring to the figures, FIG. 1 illustrates that the improved feeder 10 can be filled with, and provide for animals, virtually any non-liquid feed or supplement such as corn, pellets, protein powder, or solid animal and ingestible that will flow with gravity (collectively referred to herein as “feed”). The shape and angle of the hopper 12, and the design of the protein head 16 keep the feed or supplement from flowing onto the ground.

Feed is loaded into the feeder 10 through an aperture that is covered by a hinged lid 18. The feeder 10 has a hollow interior to accept feed. Gravity pulls the feed downwardly from the hopper 12 to the head 16. The head 16 has one or more feed ports 22 that allow animals to access the feed, but that resist feed from just running out onto the ground. The lid 18 may be held in place using a latch 30. Likewise, a lock 48 may be used to resist the opening of the latch 30.

In one embodiment, the hopper 12 is inserted and urged into the cradle 14 such that the rack 20 holds the feeder 10 in the correct position to dispense feed to animals. The hopper 12 and cradle 14 are shaped and sized to join together. The rack 20 is essentially a frame with legs 24 extend downwardly from a cradle 14 designs to hold the feeder 10 in position. The legs 24 are attached to the cradle 14 and extend downwardly. At an end opposite of the cradle 14, a foot 26 may be attached to the leg 24. The foot 26 helps keep the leg 24 from inserting into the earth. In order to provide strength for the rack 40, appropriate braces 28 may be added to the rack 20 structure. The cradle 14 has an outer circumference that defines a cradle aperture through which the bottom of the feeder 10 may be inserted. A shoulder 32 attached to the side of the hopper 12 engages with the cradle 14 to hold the feeder 10 in place. It is anticipated that the feeder 10 baby inserted into the cradle 14 without a shoulder 32. However, the weight of the feeder 10 would cause it to be difficult to remove the feeder 10 at a later time. In FIG. 1, the improved feeder 10 is shown held on a rack 20, however the feeder 10 may be held in place in a variety of other embodiments, such as suspending the feeder 10 from a tree or other structure.

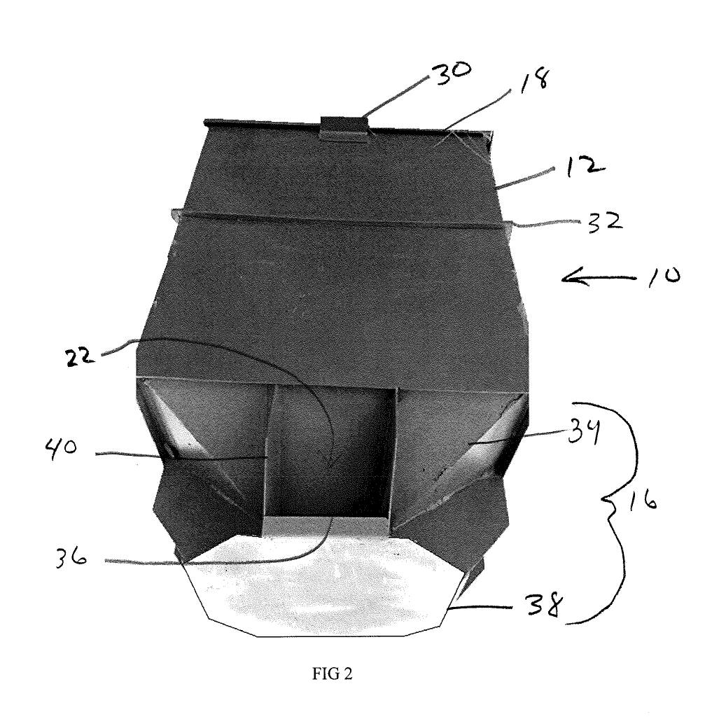

FIG. 2 shows the feeder 10 removed from the cradle 14. When in use the feeder 10 can be slid into an aperture of the cradle 14 which holds the feeder 10 off the ground in an upright position. The external shape of the feeder 10 and the shape of the cradle 14 aperture tend to cause the feeder 10 to come to rest in a relatively vertical position when the feeder 10 is urged through the cradle 14 aperture and held by the rack 20. The aperture is sized so that the head 16 and lower portion of the hopper 12 pass through the aperture, but the funnel-like shape of the hopper 12 causes the hopper 12 to be held in the cradle 14 aperture. The outer circumference of the hopper 12 increases from its hopper bottom 12b to its hopper top 12a at the top of the feeder 10.

FIG. 2 also shows the bottom plate 38 and the feed port 22 of the head 16. Support members 40 form the sides of the feed port 22, and look somewhat fin-like and are attached to the bottom plate 38 of the head 16. The head angle 34 directs feed in the interior of the feeder and toward the center and bottom of the head 16 where it is dispersed out through the feed ports 22. Movement of the feed out of the feed port 22 tends to be arrested by the feed arrest member 36.

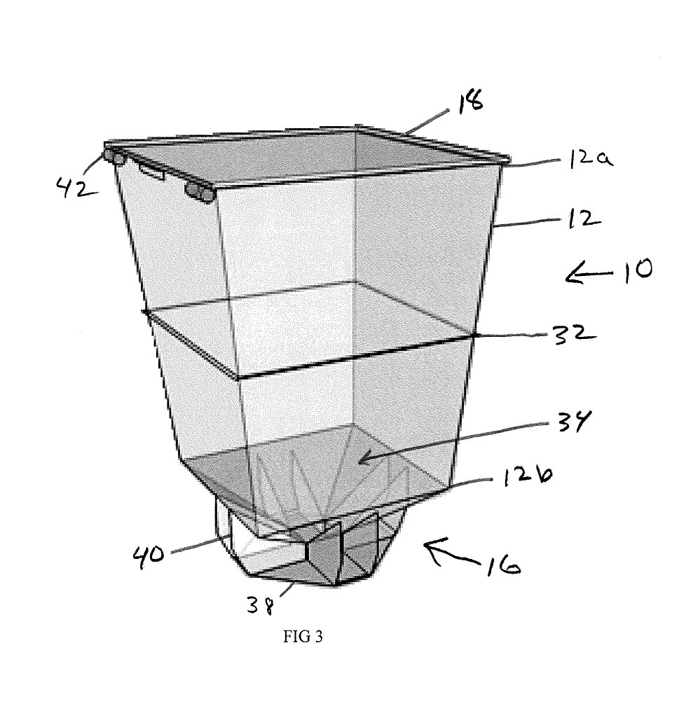

FIG. 3 shows the body of the feeder removed from the cradle with the sides of the hopper 12 being semi-transparent in order to illustrate the interior of the hopper 12. The feeder 10, and consequently the hopper 12, are generally hollow, inverted truncated pyramid, or inverted truncated cone, shaped with the circumference anticipated to be circular or polyhedral. In the figures herein, the feeder 10 circumference is shown to be generally rectangular however it is anticipated that many other circumference shapes could be used. A lid 18 is rotationally attached, via one or more hinges 42, to the hopper top 12a. The movable lid 18, when opened, allows feed to be deposited in the interior of the feeder 10, and when closed, helps keep moisture and other contaminants out of the interior of the feeder 10. FIG. 3 helps illustrate the angles from the Hopper top 12a to the hopper bottom 12b, and in the head 16. The circumference of the hopper 12 at the hopper top 12a is greater than the circumference of the hopper bottom 12b. Thus, the sides of the hopper 12 angle inwardly to create a hopper angle 44. The head 16 is at the bottom of the inverted truncated pyramid shape created by the hopper 12 in the head 16. The hopper 16 sides angle inwardly to an aperture, and the inward angle creates a head angle 34. Together, the hopper angle 44 and the head angle 34 tend to direct feed into the center bottom aperture of the head 16. A bottom plate 38 is connected at the bottom of the head 16.

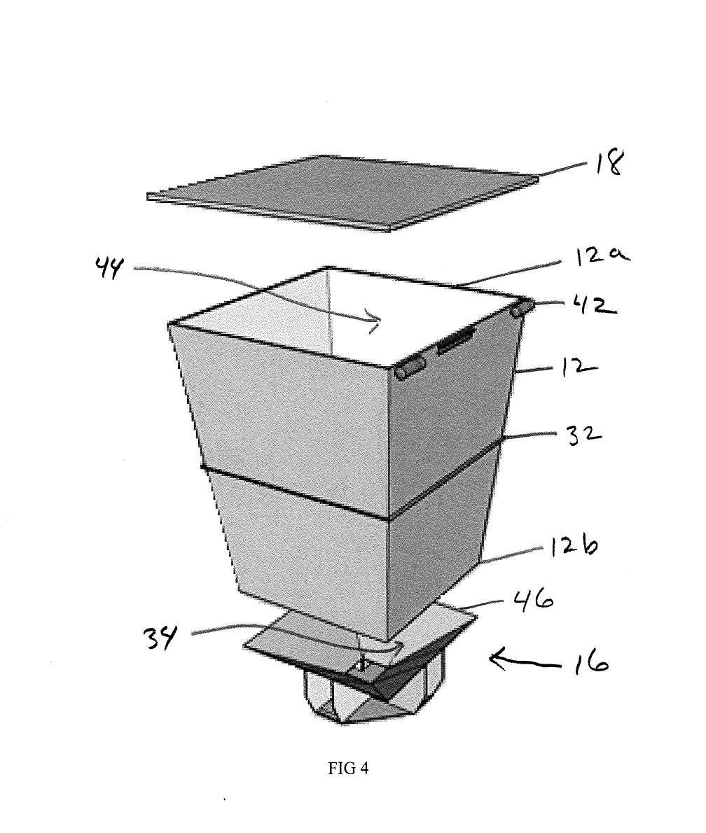

FIG. 4 is an exploded, perspective view of the feeder. In this view, the head 16 and the lid 18 are shown removed from the hopper 12. The bottom feed aperture 50 leading to the bottom plate is shown. Feed tends to travel down through the interior of the hopper 12 in the head 16 and exits through the feed aperture 50 where it rests on the bottom plate 38 until consumed by an animal. At the hopper top 12a is an aperture that allows feed to be filled into the feeder 10. The top aperture is covered by a hinged lid 18 that is swung open to load the feeder 10 with feed, and closed when in use to keep rain, debris, pests, and the like from accessing the interior of the feeder 10 and the feed. This view also shows the funnel-like nature of the interior of the hopper 12. The head 16 is shown with the bottom plate 38 and support member fins 40.

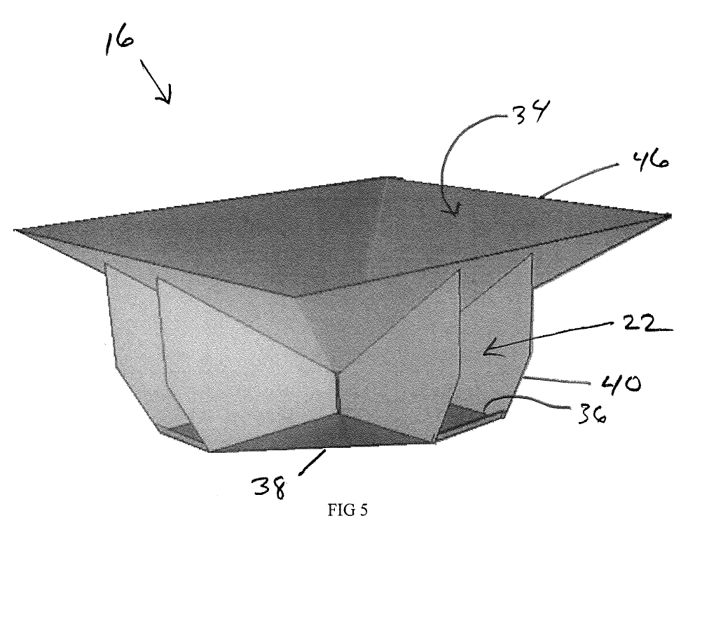

FIG. 5 shows the head 16 of the improved feeder 10. The head 16 is shaped to fit against the hopper bottom 12b. In the illustrated embodiment, the head 16 has an inverted, hollow pyramid shape in the interior that helps feed not get clogged in the interior as it drops. The head 16 has a bottom plate 38 that arrests the downward movement of the feed. The feeder 10 may have one (1) or more feed ports 22. Animals are directed to the feed ports 22 by fins 40, which also act as support members and attach to the bottom plate 38 of the head 16. This view also helps show the funnel-like shape of the interior portion (although shown from the exterior) head 16. This view shows the feed arrest members 36 that extend across the bottom portion of the feed ports 22. The feed arrest members 36 are extensions of, or attached to, the bottom plate 38 and turn generally upwardly in order to help keep feed from pouring out of the feeder 10 when an animal is not eating.

Feed drops from the hopper 12 into the head 16 and is directed towards the feed aperture 50 of the head 16 by the funnel or inverted pyramid-like shape of the head 16. The support members 40 hold the bottom plate 38 in place below the bottom aperture 50. Feed arrest members 36 extend across the bottom portion of the feed ports 22 to help diminish unwanted feed spillage.

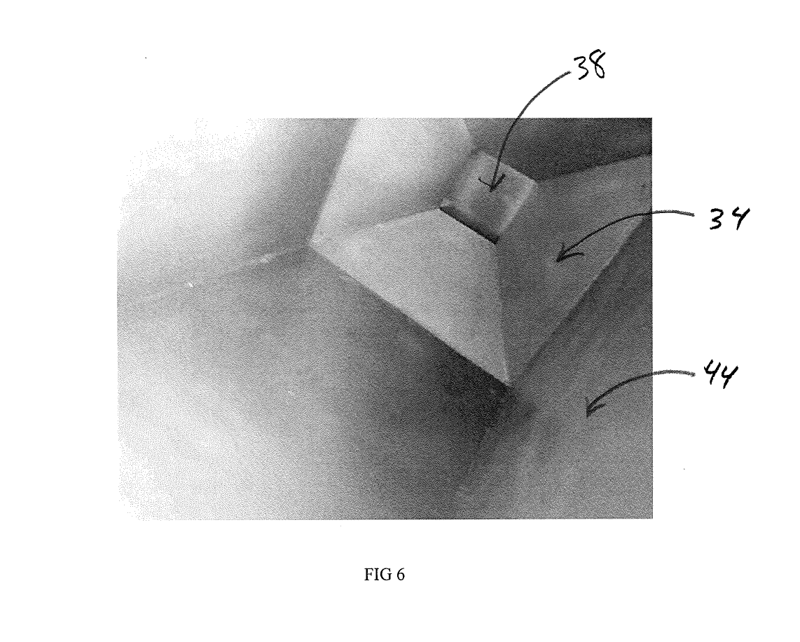

FIG. 6 is a view of the interior of the feeder hopper 12 and head 16. It illustrates the funnel shaped interior of the feeder 10 is shown having a hopper angle 44 and a head angle 34. The funnel-shaped interior of the feeder 10 helps the feed to fall downwardly and directed toward the center feed aperture 50 when the feeder 10 is in use. At the center of the feeder 10 interior below the feed aperture 50 can be seen the bottom plate 38, which arrests the movement of the feed and upon which the feed rests on felt eaten by an animal or otherwise removed. The feed ports 22 allow animals access to the feed lying on the bottom plate 38.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An apparatus for feeding animals comprising:
a hopper wherein said hopper is hollow and has a generally inverted pyramid shape with a relatively larger aperture at a hopper top and a relatively smaller aperture at a hopper bottom;
a lid rotationally attached to said hopper top, wherein said lid is sized and shaped to cover said aperture at said hopper top;
a head having a generally hollow inverted pyramid shaped interior, and wherein a rim of said head is sized and shaped to the roughly equal to said hopper bottom;
wherein a bottom of said Ed interior has a feed aperture;
wherein said hopper bottom is attached to said head rim;
wherein said hopper interior is at a hopper angle and said head interior is at a head angle; and
a bottom plate attached to said head below said feed aperture by fins, wherein said fins are generally horizontal and form a feed port.

2. The apparatus of claim 1, further comprising a feed arrest member attached to said bottom plate edge.

3. The apparatus of claim one, further comprising:
a rack comprising a cradle having a circumference defining a cradle aperture wherein said cradle aperture is sized and shaped to accept said head and said hopper bottom through said cradle aperture; and
a shoulder attached on the outside of said hopper, said shoulder being engageable with said cradle such that said hopper will not travel completely through said cradle aperture; and
one or more legs attached to said cradle.
